(19) United States
(12) Patent Application Publication
(10) Pub. No.: US 2025/0087997 A1
(43) Pub. Date: Mar. 13, 2025

(54) SMART CLAMP SYSTEM FOR AUTOMOBILE EMERGENCY STARTING

(71) Applicant: Dongguan Chuangyi New Energy Technology Co., Ltd., Dongguan City (CN)

(72) Inventor: Xichun Chen, Dongguan City (CN)

(21) Appl. No.: 18/503,378

(22) Filed: Nov. 7, 2023

(30) Foreign Application Priority Data
Sep. 8, 2023 (CN) 2023112025600

(51) Int. Cl. H02J 1/10; H02J 7/00

(52) U.S. Cl. CPC H02J 1/122; H02J 7/0034

(57) ABSTRACT

A smart clamp system for automobile emergency starting is disclosed, including a smart clamp and a control board. The smart clamp includes a power interface, a first clamping end and a second clamping end; the first clamping end and the second clamping end are electrically connected to the power interface and electrodes for the automobile battery. By such designs, which can automatically recognize positive and negative poles of the automobile battery and assign electrical signals adapted to them, thereby can reduce risk of reverse short-circuit.

### TECHNICAL FIELD

The present application belongs to the technical field of automobile emergency start power supply, and particularly to a smart clamp system for automobile emergency starting.

### BACKGROUND

Automotive emergency start power supply is a portable power supply device that is usually used to clamp onto an automobile battery to start an automobile engine. It is also known as an automobile start power supply, an automobile emergency power supply, and an automobile charger, and so on. The automotive emergency start power supply usually includes a battery module, a controller, and a power management system, and is mainly used to convert direct current energy from battery into a current and voltage output suitable for starting the automobile engine to start the start the automobile engine. The automotive emergency start power supply usually configured with a variety of connector such as clamps and USB interfaces, which may be clamped onto the automobile battery to start the engine, or to charge electronic devices such as mobile phones and tablets. The automotive emergency start power supply connects the clamps, especially a positive clamp connects a positive pole of the automobile battery and a negative clamp connects a negative pole of the automobile battery, because the positive and negative poles of the automobile battery are connected to a power terminal of the automobile engine, when the automobile battery is in an abnormal state such as under-voltage, the automobile emergency start power supply may provide a start signal for the automobile engine. However, in practice, due to inexpertness or influence of light and other reasons, there are cases where the positive and negative poles are reversed, resulting in short circuits and other dangerous situations.

By reasons of the foregoing, the existing automotive emergency start power supply has technical problems of reverse short circuit risk.

### SUMMARY

Aiming at deficiencies of the above existing technologies, the present disclosure provides a smart clamp system for automobile emergency starting, which can automatically recognize positive and negative poles of an automobile battery and assign electrical signals adapted to the positive and negative poles of an automobile battery, and thus can reduce risk of reverse short-circuit.

In some embodiments of the present disclosure, a smart clamp system for automobile emergency starting is provided, including a smart clamp and a control board. The smart clamp is configured for electrically connecting an emergency start power supply to a power terminal of an automobile engine via electrodes for the automobile battery. The smart clamp includes a power interface, a first clamping end and a second clamping end; the power interface is electrically connected to the emergency start power supply, the first clamping end and the second clamping end are configured to electrically connect to the power interface and the electrodes for the automobile battery.

In some embodiments of the present disclosure, the control board is arranged in an interior of the smart clamp. And the control board is configured to, automatically obtain polar signals of the first clamping end and the second clamping end after the first clamping end and the second clamping end being electrically connected to the electrodes for the automobile battery; determine polarities of the electrodes for the automobile battery based on the polar signals of the first clamping end and the second clamping ends; and transmit an electrical signal matching positive and negative polarities of the automobile battery to the electrodes for the automobile battery based on an obtained polarities of the electrodes for the automobile battery by determination, to provide an emergency start signal for the power terminal of the automobile engine.

In some preferred embodiments of the present disclosure, the smart clamp for automobile emergency starting further includes a physical start switch, arranged on one side of the smart clamp. And the control board is configured to, obtain polar signals of the first clamping end and the second clamping end based on a pressing signal of the physical start switch after the first clamping end and the second clamping end being electrically connected to the electrodes for the automobile battery; determine the polarities of the electrodes for the automobile battery based on the polar signals of the first clamping end and the second clamping; and transmit the electrical signal matching the positive and negative polarities of the automobile battery to the electrodes for the automobile battery based on the obtained polarities of the electrodes for the automobile battery by determination, to provide the emergency start signal for the power terminal of the automobile engine.

In some preferred embodiments of the present disclosure, the physical start switch includes a transparent cover that configured with an LED light module below the translucent cover, and the LED light module is electrically connected to the control board. The control board is configured to control the LED light module to emit light to illuminate the transparent cover after the first clamping end and the second clamping end being electrically connected to the electrodes for the automobile battery.

In some preferred embodiments of the present disclosure, after the first clamping end and the second clamping end being electrically connected to the electrodes for the automobile battery and a first preset delay time being elapsed, in response to the automobile engine does not start, the control board is configured to control the LED light module to blink, and alert a user to press the physical start switch to obtain the pressing signal of the physical start switch.

In some preferred embodiments of the present disclosure, after the first clamping end and the second clamping end being electrically connected to the electrodes for the automobile battery, and a second preset delay time being elapsed since the user presses the physical start switch, in response to the automobile engine starts successfully, the control board is configured to control the LED light module to turn off; alternatively in response to the automobile engine does not start, the control board is configured to control the LED light module to blink and then turn off, and alert the user that emergency start has failed.

In some preferred embodiments of the present disclosure, the smart clamp for automobile emergency starting further includes an audible alert module and a first photosensitive sensor, the audible alert module and the first photosensitive sensor are arranged on the smart clamp. After the first clamping end and the second clamping end being electrically connected to the electrodes for the automobile battery and a first preset delay time being elapsed, in response to the automobile engine does not start, the control board is configured to, obtain first detection data of the first photosensitive sensor, determine it is daytime based on the first detection data, control the audible alert module to release a sound, and alert the user to press the physical start switch to obtain the pressing signal of the physical start switch.

In some preferred embodiments of the present disclosure, after the first clamping end and the second clamping end being electrically connected to the electrodes for the automobile battery and the second preset delay time being elapsed since the user presses the physical start switch, in response to the automobile engine starts successfully, the control board is configured to control the audible alert module to turn off; alternatively in response to the automobile engine does not start, the control board is configured to control the audible alert module to release the sound and alert the user that emergency start has failed.

In some preferred embodiments of the present disclosure, the smart clamp for automobile emergency starting further includes an LED lighting module arranged on the smart clamp and electrically connected to the control board. After the smart clamp system for automobile emergency starting is started up, the control board is configured to control illumination of the LED lighting module, to facilitate the user connects the first clamping end and the second clamping end to the power interface.

In some preferred embodiments of the present disclosure, the smart clamp for automobile emergency starting further includes a second photosensitive sensor, arranged on the smart clamp and electrically connected to the control board. After the smart clamp system for automobile emergency starting is started up, the control board is configured to, obtain second detection data of the second photosensitive sensor, determine it is nighttime based on the second detection data, and control illumination of the LED lighting module; alternatively determine it is daytime based on the second detection data, then the control board is configured not to control the illumination of the LED lighting module.

In some preferred embodiments of the present disclosure, the smart clamp for automobile emergency starting further includes an input low voltage protection module, an input high voltage protection module, a reverse charge protection module, a reverse connection protection module, a high temperature protection module, a start-up delay protection module, a standby delay protection module, and a short-circuit protection module. The input low voltage protection module, the input high voltage protection module, the reverse charge protection module, the high temperature protection module, the start-up delay protection module, the standby delay protection module, and the short-circuit protection module are integrated on the control board.

In comparison with existing technologies, the present disclosure has at least following technical advantages. The smart clamp for automobile emergency starting of the present disclosure includes the smart clamp and the control board. The smart clamp is configured for electrically connecting the emergency start power supply to the power terminal of the automobile engine via electrodes for the automobile battery. The smart clamp includes the power interface, the first clamping end and the second clamping end; the power interface is electrically connected to the emergency start power supply, the first clamping end and the second clamping end are configured to electrically connect to the power interface and the electrodes for the automobile battery. The control board is arranged in the interior of the smart clamp, and the control board is configured to, automatically obtain polar signals of the first clamping end and the second clamping end after the first clamping end and the second clamping end being electrically connected to the electrodes for the automobile battery; determine the polarities of the electrodes for the automobile battery based on the polar signals of the first clamping end and the second clamping ends; and transmit the electrical signal matching positive and negative polarities of the automobile battery to the electrodes for the automobile battery based on the obtained polarities of the electrodes for the automobile battery by determination, to provide the emergency start signal for the power terminal of the automobile engine. By such designs, which can automatically recognize positive and negative poles of the automobile battery and thereby assign electrical signals adapted to the positive and negative poles of an automobile battery, and thus can reduce risk of reverse short-circuit.

### BRIEF DESCRIPTION OF THE DRAWINGS

The accompanying drawings illustrated herein are used to provide a further understanding of the present invention and form a part of the present invention, illustrative embodiments of the present disclosure and their description are used to explain the present invention and do not constitute an undue limitation of the present invention. Some specific embodiments of the present disclosure will be described in detail below in an exemplary and non-limiting manner with reference to the accompanying drawings. The same reference signs in the accompanying drawings indicate the same or similar parts or sections, and it should be understood by those of ordinary skill in the art that these accompanying drawings are not necessarily drawn in scale.

FIG. 1 is an architecture diagram of a smart clamp for automobile emergency starting in accordance with some embodiments of the present disclosure.

FIG. 2 is another architecture diagram of a smart clamp for automobile emergency starting in accordance with some embodiments of the present disclosure.

FIG. 3 is still another architecture diagram of a smart clamp for automobile emergency starting in accordance with some embodiments of the present disclosure.

FIG. 4 is yet another architecture diagram of a smart clamp for automobile emergency starting in accordance with some embodiments of the present disclosure.

FIG. 5 is yet another architecture diagram of a smart clamp for automobile emergency starting in accordance with some embodiments of the present disclosure.

FIG. 6 is yet another architecture diagram of a smart clamp for automobile emergency starting in accordance with some embodiments of the present disclosure.

### DETAILED DESCRIPTION OF THE EMBODIMENTS

In order to enable those of ordinary skill in the art to better understand the embodiments of the present disclosure, the technical solutions in the present disclosure will be clearly and completely described below in conjunction with the accompanying drawings in the present embodiments. Obviously, embodiments of the described embodiments are only embodiments of a portion of the present invention and are not all of the embodiments. Based on the embodiments in the present disclosure, all other embodiments obtained by those of ordinary skill in the art without making creative labor shall fall within scopes of protection of the present invention.

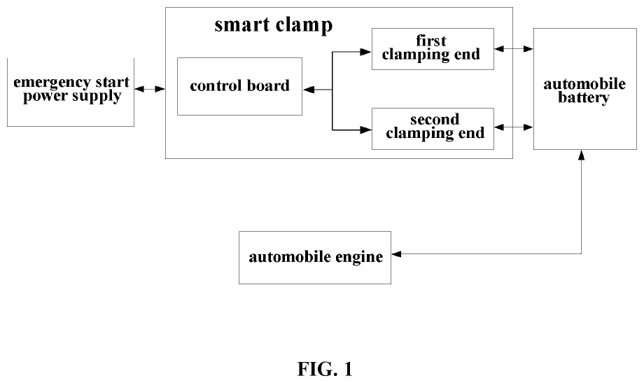

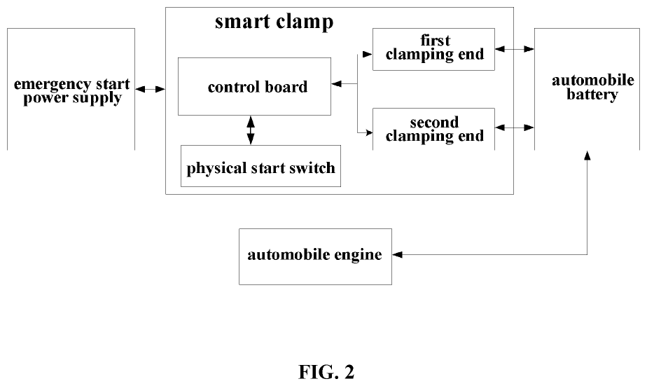

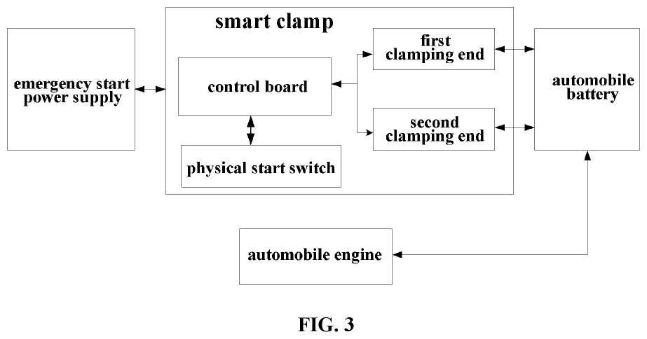

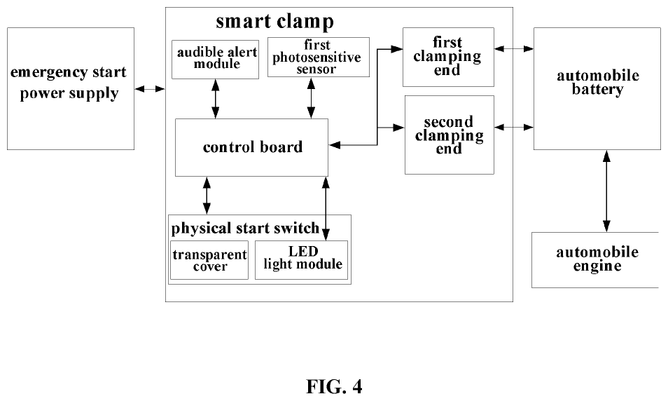

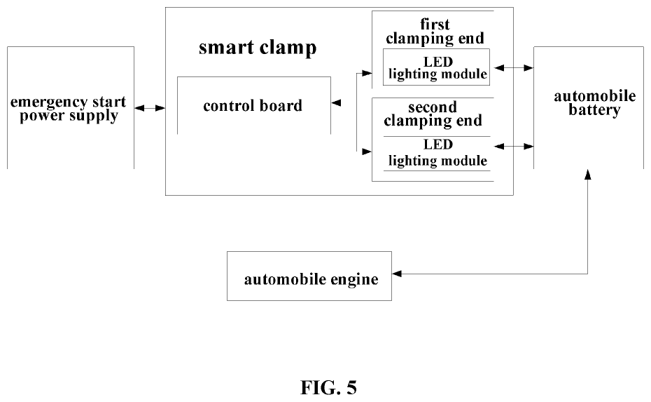

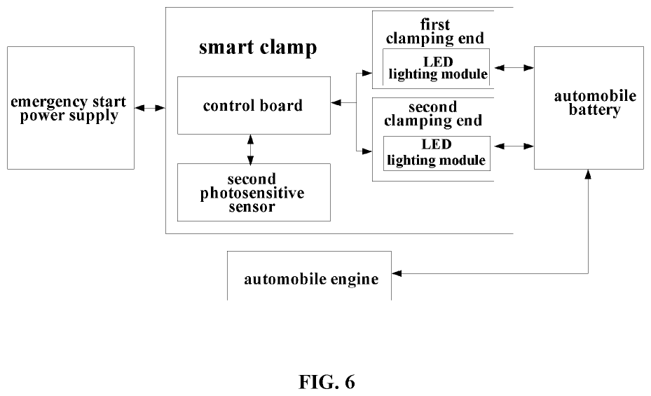

Referring to FIG. 1 to FIG. 6, in some embodiments of the present disclosure, a smart clamp system for automobile emergency starting is provided, including a smart clamp and a control board. The smart clamp is configured for electrically connecting an emergency start power supply to a power terminal of an automobile engine via electrodes for the automobile battery. The smart clamp includes a power interface, a first clamping end and a second clamping end; the power interface is electrically connected to the emergency start power supply, the first clamping end and the second clamping end are configured to electrically connect to the power interface and the electrodes for the automobile battery. The control board is arranged in an interior of the smart clamp. And the control board is configured to, automatically obtain polar signals of the first clamping end and the second clamping end after the first clamping end and the second clamping end being electrically connected to the electrodes for the automobile battery; determine polarities of the electrodes for the automobile battery based on the polar signals of the first clamping end and the second clamping ends; and transmit an electrical signal matching positive and negative polarities of the automobile battery to the electrodes for the automobile battery based on an obtained polarities of the electrodes for the automobile battery by determination, to provide an emergency start signal for the power terminal of the automobile engine. By such designs, which can automatically recognize positive and negative poles of an automobile battery and assign electrical signals adapted to the positive and negative poles of an automobile battery, and thereby can reduce risk of reverse short-circuit.

It should be noted that, in the embodiments of the present disclosure, by means of connecting the emergency start power supply with the automobile battery via the smart clamp, which can provide a fast emergency start signal when the automobile battery is insufficiently charged or unable to start the engine, which can help a drive to quickly start the vehicle in an emergency situation, and prevent the driver from being stranded in a remote area or a dangerous state.

It also should be noted that, in the embodiments of the present disclosure, the control board is configured to, automatically obtain the polar signals of the first clamping end and the second clamping end after connecting the smart clamp, and determine these signals, which can accurately identify the polarities of the electrodes for the automobile battery, therefore can effectively avoid damages or safety problems caused by the user's wrong connection.

It also should be noted that, in the embodiments of the present disclosure, the control board is configured to, determine the polarities of the electrodes for the automobile battery based on the polar signals, and transmit a matching electrical signal to the electrodes for the automobile battery, which can provide the emergency start signal for the power terminal of the automobile engine correctly, thereby can ensure that the starting process is carried out smoothly.

It also should be noted that, in the embodiments of the present disclosure, by means of automatic polarities recognition and matching electrical signal transmission, the system can ensure that the smart clamp is correctly connected to the electrodes for the automobile battery, thereby avoiding damage or danger caused misuse and incorrect connection, making the system safer and more reliable in use.

In some preferred embodiments of the present disclosure, the smart clamp for automobile emergency starting further includes a physical start switch, arranged on one side of the smart clamp. And the control board is configured to, obtain polar signals of the first clamping end and the second clamping end based on a pressing signal of the physical start switch after the first clamping end and the second clamping end being electrically connected to the electrodes for the automobile battery; determine the polarities of the electrodes for the automobile battery based on the polar signals of the first clamping end and the second clamping; and transmit the electrical signal matching the positive and negative polarities of the automobile battery to the electrodes for the automobile battery based on the obtained polarities of the electrodes for the automobile battery by determination, to provide the emergency start signal for the power terminal of the automobile engine.

It should be noted that, in the embodiments of the present disclosure, the physical start switch allows the user to manually trigger an emergency start function of the smart clamp system. The user only needs to press the physical start switch to activate the emergency start process without relying on other auxiliary equipment or automatic detection, thus can enhance user control and make the system more flexible, and allowing the user to decide when to activate the emergency start process as needed. It should be understood that, in the embodiments of the present disclosure, the control board can acquire the polar signals of the first clamping end and the second clamping end in two ways. One way is automatically, and the other way is through the pressing signal of the physical start switch. Such dual acquisition of polar signals can increase the reliability of the system, and even if there is abnormality in the automatic acquisition, the user can still start the emergency start process through the physical start switch.

In some preferred embodiments of the present disclosure, the physical start switch includes a transparent cover that configured with an LED light module below the translucent cover, and the LED light module is electrically connected to the control board. The control board is configured to control the LED light module to emit light to illuminate the transparent cover after the first clamping end and the second clamping end being electrically connected to the electrodes for the automobile battery.

It should be noted that, in the embodiments of the present disclosure, by adding the transparent cover and LED light module to the physical start switch, a visual indication function can be provided. When the smart clamp system is connected to the electrodes for the automobile battery, the control board can control the LED light module to illuminate the transparent cover. In this way, the user can see clearly a position of the physical start switch by observing the luminance of the transparent cover, and when it is necessary to press the physical start switch, it is convenient for the user to press the physical start switch for a first time. In addition, by setting the transparent cover and the LED light module, which can enhance an interaction experience between the user and the system, and thus making the system more intuitive and easily to use. Moreover, in case of emergency, the smart clamp system may need to be activated at night or in the dark, the transparent cover and the LED light module can improve a visibility of the smart clamp in the dark, thereby helping the user to locate and operate the physical start switch more easily.

It should be noted that, in the embodiments of the present disclosure, the physical start switch can be pressed manually to start the system for polarity determination after the system's automatic polarity determination fails to work, solving the problem of intelligent determination failure, and it can also provide the visual indication function, which is convenient for the user to press the physical start switch for the first time, thereby enhancing the user's interaction experience with the system and making the system more intuitive and easy to use.

In some preferred embodiments of the present disclosure, after the first clamping end and the second clamping end being electrically connected to the electrodes for the automobile battery and a first preset delay time being elapsed, if the automobile engine does not start, the control board is configured to control the LED light module to blink, and alert the user to press the physical start switch to obtain the pressing signal of the physical start switch.

It should be noted that, in the embodiments of the present disclosure, in the smart clamp system for automobile emergency starting, the first preset delay time is set, which is a time to wait after the smart clamp is connected to the automobile battery. If the automobile engine does not start after the first preset delay time, the control board will control the LED light module to blink, thus providing an automatic press alert function to alert the user that the emergency start has not been successful activated, and it is need to press the physical start switch by the user to perform the activation. After the user presses the physical start switch for the first time, if the automobile engine does not start, the LED light module of the system will blink and alert the user to press the physical start switch to get the start signal. Through an interactive guidance with the user, it can reduce the user's uncertainty about the system and increase the user's sense of participation and confidence.

In some preferred embodiments of the present disclosure, after the first clamping end and the second clamping end being electrically connected to the electrodes for the automobile battery, and a second preset delay time being elapsed since the user presses the physical start switch, if the automobile engine starts successfully, the control board is configured to control the LED light module to turn off; alternatively if the automobile engine does not start, the control board is configured to control the LED light module to blink and then turn off, and alert the user that emergency start has failed.

It should be noted that, in the embodiments of the present disclosure, after the second preset delay time has been lapsed since the user pressed the physical start switch, depending on whether the automobile engine is successfully started or not, the control board controls the LED light module to operate accordingly. Is the automobile engine is successfully started, the LED light module will be turned off; while if the start fails, the LED light module will blink and then turn off. In this way, it can clearly indicate to the user whether the emergency start is successful or not, and thereby reducing the user's guess and uncertainty. By observing the status of the LED light module, the user is immediately informed of the start result without having to wait too long. Such real-time feedback helps the user to quickly make decisions on subsequent operations, such as trying to start again, checking the automobile battery connection, or seeking other solutions. In addition, the LED light module blinks light and then turns off, which alert the user that the emergency start has failed, thereby can improve a friendliness of the interaction with the user. Compared with direct continuous blinking, blinking and then turning off can avoid excessive interference and ensure that the user can receive the alert message clearly. In addition, the quick feedback of the start result helps to improve the efficiency of emergency start. If the start is successful, the LED light module shuts down without wasting too much time and resources. If the start fails, the user can take further measures immediately, which can improve the efficiency of problem solving.

In some preferred embodiments of the present disclosure, the smart clamp for automobile emergency starting further includes an audible alert module and a first photosensitive sensor, the audible alert module and the first photosensitive sensor are arranged on the smart clamp. After the first clamping end and the second clamping end being electrically connected to the electrodes for the automobile battery and a first preset delay time being elapsed, if the automobile engine does not start, the control board is configured to, obtain first detection data of the first photosensitive sensor, determine it is daytime based on the first detection data, control the audible alert module to release a sound, and alert the user to press the physical start switch to obtain the pressing signal of the physical start switch.

It should be noted that, in the embodiments of the present disclosure, by providing audio-visual alerts in addition to visual indications (LED light module), the LED light module may not be sufficiently conspicuous in daytime environments, especially in bright outdoor conditions, whereas audible alerts are more effective. With the help of the audible alert module and the first photosensitive sensor, the system is optimized for user interaction. After pressing the physical start switch for the first time, if the automobile engine does not start and it is daytime, an audible alert is given to the user to press the physical start switch. Such optimization of the user interaction helps the user to cope with complex start situations.

In some preferred embodiments of the present disclosure, after the first clamping end and the second clamping end being electrically connected to the electrodes for the automobile battery and the second preset delay time being elapsed since the user presses the physical start switch, if the automobile engine starts successfully, the control board is configured to control the audible alert module to turn off; alternatively if the automobile engine does not start, the control board is configured to control the audible alert module to release the sound and alert the user that emergency start has failed.

It should be noted that, in the embodiments of the present disclosure, after the second preset delay time has been elapsed since the user presses the physical start switch, depending on the automobile engine is successfully or not, the control board control the audible alert module to perform corresponding operation. If the automobile engine is successfully started, the audible alert module will be closed. And if the start fails, the audible alert module will release a sound, to alert the user to close after the emergency start fails. In this way, it is possible to clearly indicate to the user whether the emergency start has been successful or not, thereby can reduce guesswork and uncertainty for the user. The audible alert can replace visual indication to some extent, and are particularly suitable for situations where the LED light module cannot be seen (for example, low light or limited vision), but still allow the user to be informed of the outcome of the start. In addition, the audible alert module can provide the user with timely feedback without need for the user to pay special attention to the LED light module or other display devices. The user is informed of the start result by the sound and can make quicker decisions on subsequent operations. The automatic shutdown function of the audible alert module allows the user to stop the audible alert without additional action after the emergency start failure, thus can save the user's operation steps and effort.

In some preferred embodiments of the present disclosure, the smart clamp for automobile emergency starting further includes an LED lighting module, arranged on the smart clamp and electrically connected to the control board. After the smart clamp system for automobile emergency starting is started up, the control board is configured to control illumination of the LED lighting module, so as to facilitate the user connects the first clamping end and the second clamping end to the power interface. Further, the LED lighting module is arranged on the first clamping end and the second clamping end.

It should be noted that, in the embodiments of the present disclosure, the LED lighting module provides the user with a lighting function that makes it easier to connect the smart clamp. A process of connecting the smart clamp to the automobile battery often occurs during vehicle breakdowns or emergency situations, which may occur in poorly lit environments, such as at night or in dimly lit indoor spaces. Through the illumination of the LED lighting module, the user can more clearly see positions of the first clamping end, the second clamping end and the electrodes of the automobile battery, thus making it easier to perform connection operations. In the emergency, the user may need to quickly perform the emergency start operation, which may be delayed if not properly operation. With the illumination of the LED lighting module, the user can clearly see the locations and the status of the connection, thus reducing the possibility of incorrect connection and improving the connection efficiency. The user can locate and operate the smart clamp more easily in dark environments without need to prepare additional light sources, thus saving time and energy for the user in emergency situations.

In some preferred embodiments of the present disclosure, the smart clamp for automobile emergency starting further includes a second photosensitive sensor, arranged on the smart clamp and electrically connected to the control board. After the smart clamp system for automobile emergency starting is started up, the control board is configured to, obtain second detection data of the second photosensitive sensor, determine it is nighttime based on the second detection data, and control illumination of the LED lighting module; alternatively determine it is daytime based on the second detection data, then the control board is configured not to control the illumination of the LED lighting module.

It should be noted that, in the embodiments of the present disclosure, the second photosensitive sensor enables the smart clamp system to have the intelligent lighting control function. Based on the night detection data obtained by the second photosensitive sensor, the control board can determine whether it is currently night. If it is night, the control board will control the LED lighting module to emit light, so as to assist the user in connecting the smart clamp. While it is daytime, the LED lighting module will not be controlled to emit light, avoiding unnecessary energy consumption. Moreover, the introduction of the second photosensitive sensor optimizes the user's experience. The smart clamp system can intelligently adjust the lighting according to the light conditions, avoiding unnecessary lighting interference during the daytime. Meanwhile, it provides lighting assistance at night, making it convenient for the user to connect the smart clamp in dark environments, increasing the user's satisfaction. Thus the setting of the second photosensitive sensor can increase an environmental adaptability of the smart clamp system, so that the system is able to intelligently adjust the use of the LED lighting module according to the lighting conditions, thereby adapting to different environments and usage scenarios.

In some preferred embodiments of the present disclosure, the smart clamp for automobile emergency starting further includes an input low voltage protection module, an input high voltage protection module, a reverse charge protection module, a reverse connection protection module, a high temperature protection module, a start-up delay protection module, a standby delay protection module, and a short-circuit protection module. The input low voltage protection module, the input high voltage protection module, the reverse charge protection module, the high temperature protection module, the start-up delay protection module, the standby delay protection module, and the short-circuit protection module are integrated on the control board.

It should be noted that, in the embodiments of the present disclosure, the input low voltage protection module is configured to monitor an input voltage of the automotive emergency start system, and when the input voltage falls below a set threshold, the module will trigger a protective measure to prevent the battery from being over-discharged to avoid damage to the battery. The input high voltage protection module is configured to monitor the input voltage, but its purpose is to prevent the input voltage from being too high, thus avoiding damage or fault of the system's circuitry. The reverse charge protection module is configured to prevent a reverse current from damaging the system when the automotive emergency start system is connected to a reverse voltage. The high temperature protection module is configured to monitor the system temperature, and when the temperature reaches a preset high temperature threshold, it will trigger the protection measure to prevent overheating leading to the system failure or damage. The start-up delay protection module is configured to provide a delayed protection when starting the automotive emergency start system, to ensure stable operation of the system and then start, thereby avoiding premature start-up resulting in current surge and damage. The standby delay protection module is applied in a standby mode of the system to delay waiting for a period of time and then enter a standby state to save energy and prolong the system life. The short-circuit protection module is configured to monitor whether there is a short-circuit situation in the system, when a short-circuit is detected, it will immediately cut off the power supply to prevent excessive current from passing through the system, to protect the system and the user safety. It should be understood that, by integrating the above protection modules on the control board of the smart clamp system for automobile emergency starting, multi-leveled protection measures can be provided to effectively protect the system from damage caused by abnormal voltage, reverse current, high temperature, short circuit and other conditions. Through the combination of these protection modules, the system can operate more stably and reliably, and thereby extending the system life and reducing the cost of maintenance and repair.

In some preferred embodiments of the present disclosure, the control board is connected to the first clamping end and the second clamping end via a current detecting circuit, and when the smart clamp is connected to the automobile battery, the current detecting circuit detects a flow direction of the current on the electrodes for the automobile battery. The control board determines the polarities of the electrodes for the automobile battery based on the flow direction of the current, and transmits the electrical signals matching the positive and negative electrodes of the automobile battery to the electrodes for the automobile battery, to provide the emergency start signal for the power terminal of the automobile engine, which can ensure the correct polarity connection and minimize risk of reverse connection and sort circuit.

Finally, it should be noted that the above embodiments are only used to illustrate the technical solutions of the present disclosure, not to limit them. Although the present disclosure has been described in detail with reference to the foregoing embodiments, a person of ordinary skill in the art should understand that it is still possible to modify the technical solutions described in the foregoing embodiments, or to replace some or all of the technical features therein with the same ones. And these modifications or replacements do not make the essence of corresponding technical solutions out of the scope of the technical solutions of the various embodiments of the present disclosure.

What is claimed is:

1. A smart clamp system for automobile emergency starting, comprising
a smart clamp, configured for electrically connecting an emergency start power supply to a power terminal of an automobile engine via electrodes for an automobile battery; and
the smart clamp comprises a power interface, a first clamping end and a second clamping end; the power interface being electrically connected to the emergency start power supply, the first clamping end and the second clamping end being configured to electrically connect to the power interface and the electrodes for the automobile battery;
a control board, arranged in an interior of the smart clamp and configured to
automatically obtain polar signals of the first clamping end and the second clamping end after the first clamping end and the second clamping end being electrically connected to the electrodes for the automobile battery;
determine polarities of the electrodes for the automobile battery based on the polar signals of the first clamping end and the second clamping ends; and
transmit an electrical signal matching positive and negative polarities of the automobile battery to the electrodes for the automobile battery based on an obtained polarities of the electrodes for the automobile battery by determination, to provide an emergency start signal for the power terminal of the automobile engine.

2. The smart clamp system for automobile emergency starting according to claim 1, wherein further comprises a physical start switch, arranged on one side of the smart clamp; and
the control board is configured to
obtain polar signals of the first clamping end and the second clamping end based on a pressing signal of the physical start switch after the first clamping end and the second clamping end being electrically connected to the electrodes for the automobile battery;
determine the polarities of the electrodes for the automobile battery based on the polar signals of the first clamping end and the second clamping; and
transmit the electrical signal matching the positive and negative polarities of the automobile battery to the electrodes for the automobile battery based on the obtained polarities of the electrodes for the automobile battery by determination, to provide the emergency start signal for the power terminal of the automobile engine.

3. The smart clamp system for automobile emergency starting according to claim 2, wherein the physical start switch comprises a transparent cover that configured with an LED light module below the translucent cover, and the LED light module is electrically connected to the control board; and
the control board is configured to control the LED light module to emit light to illuminate the transparent cover after the first clamping end and the second clamping end being electrically connected to the electrodes for the automobile battery.

4. The smart clamp system for automobile emergency starting according to claim 3, wherein after the first clamping end and the second clamping end being electrically connected to the electrodes for the automobile battery and a first preset delay time being elapsed, in response to the automobile engine does not start, the control board is configured to control the LED light module to blink, and alert a user to press the physical start switch to obtain the pressing signal of the physical start switch.

5. The smart clamp system for automobile emergency starting according to claim 4, wherein after the first clamping end and the second clamping end being electrically connected to the electrodes for the automobile battery, and a second preset delay time being elapsed since the user presses the physical start switch, in response to the automobile engine starts successfully, the control board is configured to control the LED light module to turn off; alternatively in response to the automobile engine does not start, the control board is configured to control the LED light module to blink and then turn off, and alert the user that emergency start has failed.

6. The smart clamp system for automobile emergency starting according to claim 2, wherein further comprises an audible alert module and a first photosensitive sensor;
the audible alert module and the first photosensitive sensor are arranged on the smart clamp; and
after the first clamping end and the second clamping end being electrically connected to the electrodes for the automobile battery and a first preset delay time being elapsed, in response to the automobile engine does not start, the control board is configured to
obtain first detection data of the first photosensitive sensor;
determine it is daytime based on the first detection data;
control the audible alert module to release a sound; and
alert the user to press the physical start switch to obtain the pressing signal of the physical start switch.

7. The smart clamp system for automobile emergency starting according to claim 6, wherein after the first clamping end and the second clamping end being electrically connected to the electrodes for the automobile battery and the second preset delay time being elapsed since the user presses the physical start switch, in response to the automobile engine starts successfully, the control board is configured to control the audible alert module to turn off; alternatively in response to the automobile engine does not start, the control board is configured to control the audible alert module to release the sound and alert the user that emergency start has failed.

8. The smart clamp system for automobile emergency starting according to claim 7, wherein further comprises an LED lighting module, arranged on the smart clamp and electrically connected to the control board;
after the smart clamp system for automobile emergency starting is started up, the control board is configured to control illumination of the LED lighting module, to facilitate the user connects the first clamping end and the second clamping end to the power interface.

9. The smart clamp system for automobile emergency starting according to claim 8, wherein further comprises a second photosensitive sensor, arranged on the smart clamp and electrically connected to the control board;
after the smart clamp system for automobile emergency starting is started up, the control board is configured to obtain second detection data of the second photosensitive sensor, determine it is nighttime based on the second detection data, and control illumination of the LED lighting module; alternatively determine it is daytime based on the second detection data, then the control board is configured not to control the illumination of the LED lighting module.

10. The smart clamp system for automobile emergency starting according to claim 8, wherein further comprises an input low voltage protection module, an input high voltage protection module, a reverse charge protection module, a reverse connection protection module, a high temperature protection module, a start-up delay protection module, a standby delay protection module, and a short-circuit protection module; and
the input low voltage protection module, the input high voltage protection module, the reverse charge protection module, the high temperature protection module, the start-up delay protection module, the standby delay protection module, and the short-circuit protection module are integrated on the control board.
